(19) United States
(12) Patent Application Publication
(10) Pub. No.: US 2011/0271602 A1
(43) Pub. Date: Nov. 10, 2011

(54) METHOD AND DEVICE FOR CONTROLLING A VERTICALLY OR HORIZONTALLY DISPLACED GATE WHILE SECURING THE GATE CLOSURE PLANE WITH REGARD TO OBSTACLES

(76) Inventor: Dieter Bartole, Attenhofen (DE)

(21) Appl. No.: 12/738,728

(22) PCT Filed: Aug. 1, 2008
(86) PCT No.: PCT/EP08/06376

§ 371 Date: Apr. 19, 2010

(30) Foreign Application Priority Data
Oct. 18, 2007 (DE) 10 2007 050 334.4

(51) Int. Cl. E05F 15/20

(52) U.S. Cl. 49/506

(57) ABSTRACT

A simplification of a system for controlling a gate which is displaceable by means of a motorized drive mechanism across a rectangular gate aperture from an opened position into a closure position, whereby it is possible to detect an intrusion by an obstructing object during the movement of a gate into the closure position, is achieved due to the fact that a distance measurement detector beam is scanned across a scan area of preferably 90 deg. in the plane of gate movement, so that in a particular scan phase the distance measurement scanning beam impacts on the leading gate edge and subsequently impacts on the lateral boundary of the gate, wherein a comparison of distance measurement limit values, which correspond to a set of characteristic curves with regard to the leading gate edge and which correspond to a single characteristic curve with regard to the lateral boundary of the gate aperture, to the respective determined distance measurement values allows to detect an obstructing object when the respective occurring distance measurement value is smaller within particular tolerance ranges than the respective expected distance measurement limit values.

The invention relates to a method and a device for securing the gate closure plane of a gate or other closure member which closes an opening by being displaced in a vertical or horizontal plane.

It is a generally known fact of automatically operated gates or doors that safety precautions must be taken in order to prevent obstructing objects or persons from being struck by the moving gate closure edge, and to prevent the possibility of ensuing damage or injury.

To this end, it has been known to arrange at the bordering edge of automatically operated gates or doors touch-sensitive edge safety means which deactivate the gate or door drive mechanism upon occurrence of a counter force (detection of an obstacle) or even effect a “yielding action” in the sense of reversing the direction of displacement.

Another known solution affording this protection consists in the provision of photoelectric barriers or of light grids consisting of a multiplicity of photoelectric barriers closely in front of and behind the gate closure plane, to thus create a safety light curtain on either side of the gate edge.

EP 0 902 158 discloses a very advantageous system to this effect wherein it is provided to sequentially disregard particular photoelectric barriers, with the consequence that operation with only one light grid inside the very gate closure plane is made possible.

Another securing option is to provide above the gate or door aperture sensors each creating, closely in front of the gate closure plane, a safety field which reaches down to the ground and may furthermore possess a three-dimensional extension in the direction of depth. Infrared or ultrasonic sensors as well as radar sensors are customarily used for this purpose.

Another possibility consists in performing detection as early as into the approach area of the gate aperture, to thus recognize the approach of objects or persons. A safe, advantageous method in this regard is disclosed by EP 1 470 314.

The drawback of systems involving physical contact—i.e., systems responding to contact with an object—resides in the circumstance that contact will in any case be established before the sensor can effect a deactivation or the reversal of the direction of displacement of the gate drive mechanism. In a given case, this may at least result in light injuries or damages.

Solutions including photoelectric barriers and light grids present the drawback that failures will occur due to influence of external light, dirt, or inaccurate mounting. The constructive complexity is high when considering the fact that at least two system components, i.e., transmitters and receivers of a light grid system, have to be provided. If one assumes the installation of light grids in front of and behind the gate/door casement, it is thus necessary to install four components. With this solution there moreover remains a non-secured area in front of the gate edge.

The solution described in EP 1 470 314 aims at securing the approach area and may involve high complexity. Depending on the installation, safety gaps which may only be covered with the aid of two sensor systems are created in front of the gate closure plane. Securing of the gate closure plane is not the primary aim, and accordingly the area of the gate closure plane is not covered entirely.

It is an object of the invention to furnish a method having the features of the preamble of annexed claim 1, which avoids the high technical complexity required for the installation of transmitters and receivers of a comparatively large number of photoelectric barriers in order to form a light grid or light curtain within the gate closure plane, and which avoids the drawbacks that might possibly occur due to the movement of the gate leaf in the associated guide means past the transmitters and receivers and immediately in front of the pickup areas of the transmitters and receivers.

In accordance with the invention, this object is attained through the characterizing features of claim 1.

The invention also relates to a device for implementing the method according to claim 1. Advantageous configurations and developments are subject matter of the method subclaims and device subclaims.

In accordance with a preferred embodiment of a device for implementing the presently specified method, the distance scanning detector generating the distance detector beam is a scanning laser which directs a highly directional light beam at the leading gate edge and at a lateral boundary of the gate aperture, wherein it causes comparatively little difficulty to focus the scanning beam to such a degree that it will reliably impact on the leading gate edge within the tolerance limits imposed by operation of the gate, and the reflected signals of the distance scanning detector may be utilized with a high degree of accuracy for an evaluation of its propagation period measurement.

Here it should be noted expressly that the closure member to be monitored and controlled discussed in the following description and in the claims predominantly as a is a gate which mainly moves into the closure position in the vertical direction. The invention does, however, also encompass horizontally displaced gates, fences, construction site covers, swimming pool covers, loading hatch closures of cargo ships, and the like.

In the following, the invention shall be explained in more detail by way of practical examples while making reference to the enclosed drawings, wherein:

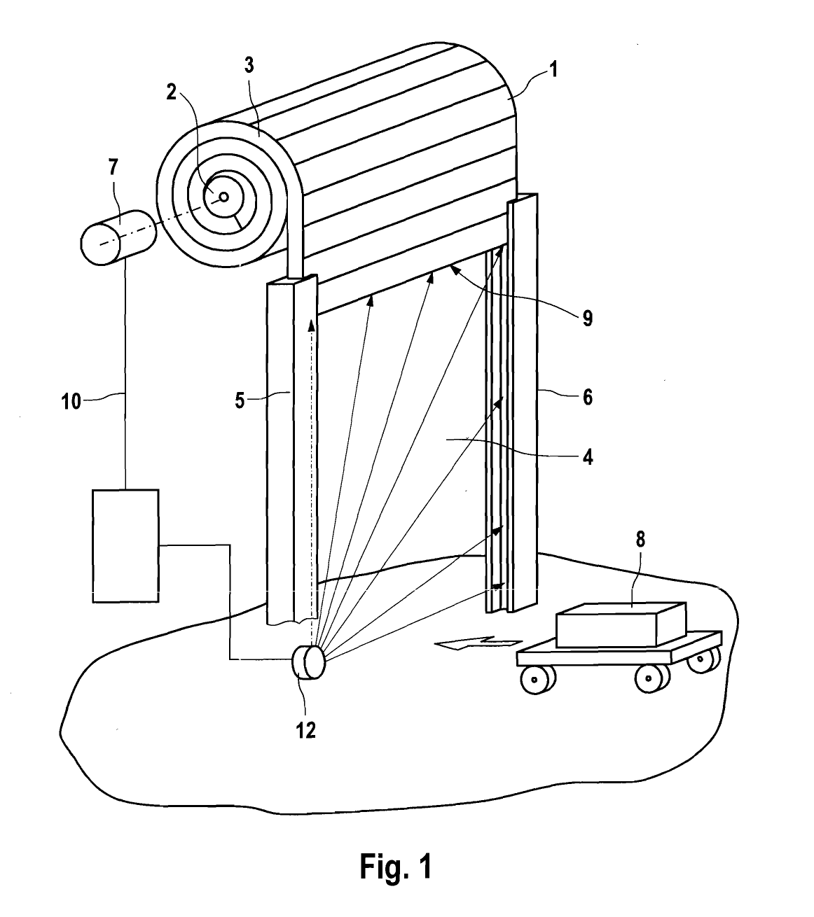

FIG. 1 is a schematic, perspective view of a segmented rolling shutter gate vertically displaceable into the opened position or into the closure position, for implementing the presently specified method;

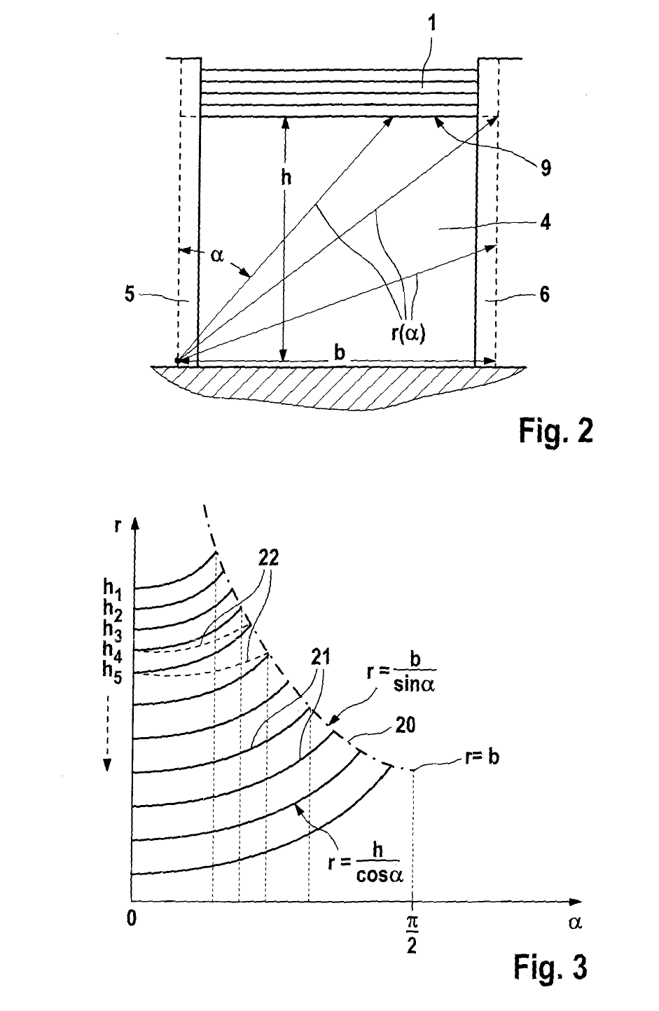

FIG. 2 is a schematic representation of a vertically displaced gate for a definition of the geometrical quantities.

FIG. 3 is a diagram giving characteristic curves for an illustration of the limit values to be obtained, in accordance with the invention, for a comparison with distance measurement values by the distance scanning detector of the presently specified device;

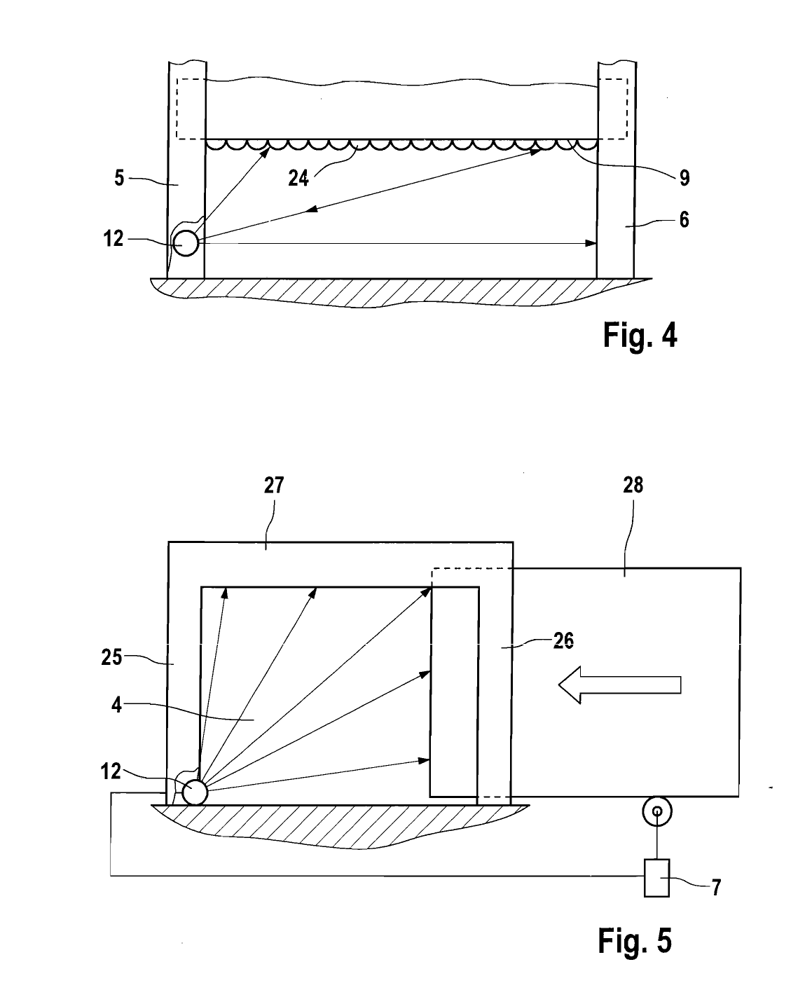

FIG. 4 is a schematic representation of a configuration of the leading gate edge for an improvement of its reflective properties;

FIGS. 5 to 8 are schematic representations of gate or door systems to which the presently specified dispositions for controlling the respective closure members may be applied; and

FIG. 9 is a three-dimensionally conceived diagram for illustrating the determination of limit values by means of the distance scanning detector.

FIG. 1 shows in a schematic, perspective representation a segmented rolling shutter gate 1 adapted to be lowered, between lateral guide members 5 and 6, from a reel 3 wound on a shaft 2 in order to shut a gate aperture 4, wherein the shaft 2 is rotated appropriately by means of a drive mechanism 7. Vice versa, the gate 1 may be raised by reversing the drive mechanism 7 so as to expose the gate aperture 4 between the guide members 5 and 6.

If an obstructing object 8 is moving toward the gate aperture 4 while the segmented gate 1 is being closed, the closing movement of the gate 1 has to be stopped by deactivating the drive mechanism 7, or in a given case by reversing the drive mechanism, so that the lower or leading gate edge 9 will not strike against the obstructing object 8 and cause damage to it or be damaged by the obstructing object 8.

When an obstructing object 8 appears, an alarm signal triggering the deactivation or/and reversal is supplied to the drive motor 7 of the segmented rolling shutter gate 1 via a line 10. This alarm signal is generated by a monitoring control means of the distance scanning detector, independently of any control means whereby, e.g., an operator activates or deactivates the drive mechanism 7 through the intermediary of the gate control, which shall be discussed in detail in the following.

In proximity of the lower corner of the gate aperture 4, i.e., in proximity of the one corner of the rectangle of the gate aperture 4 which is situated in the vicinity of the lower or leading gate edge 9 with regard to the downward movement of the leading gate edge in its closure position, there is provided a distance scanning detector including a number of different components, the entirety of which is designated by 12.

In the preferred practical example, the distance scanning detector i.a. contains a laser transmitter and receiver unit, the transmitted and received beams of which are radially deflected across a range of at least 90 deg. by means of a deflection mechanism preferably realized by a rotating mirror. The deflection mechanism is driven by a drive motor, with the instantaneous position of the deflection mirror being detected continuously upon emission and reception of a sensor signal. A control unit is supplied with the resulting values for propagation period measurement and angular position of the mirror, thus allowing the formation of pairs of values consisting of propagation period and direction of the beam.

Here it shall be assumed for the purpose of illustration of a practical example that the rotary mirror rotates clockwise, such that in the case of a scanning range of 0 to 90 deg. presently of interest, the distance measurement detector beam is initially pointed upwards and will then have a horizontal orientation at the end of this scanning range, as is shown in FIG. 2.

In detail, at the beginning of a scanning cycle, i.e., at a scanning angle α of 0 deg., the distance scanning detector 12 signals to the monitoring control means a distance h until impact of the distance measurement detector beam, which means the height of the leading gate edge 9 above zero being detected at this instant, whereas at the end of the scanning cycle, when the scanning angle α assumes a value of 90 deg., the distance scanning detector 12 signals to the monitoring control means a distance r which does, of course, correspond to the width b of the gate aperture as may be seen in FIG. 2.

The dependencies of the distance data r supplied by the distance scanning detector 12 are determined differently in portions of one scanning cycle across 90 deg., namely, in the following manner. During the movement of the leading gate edge 9 in the closing direction, the distance measurement values r change from scanning cycle to scanning cycle in accordance with diminishing height values h, in which they obey respective different characteristic curves. On the other hand, when at intermediate values of the scanning angle α the distance measurement detector beam finally impacts on the lateral boundary or on the guide member 6, a same characteristic curve will then be valid for the distance measurement value r from scan to scan; this is made clear in FIG. 3.

In the diagram of measurement values r, the dash-dotted line 20 in FIG. 3 provides the distance measurement values for the impact of the distance measurement detector beam on the lateral guide member 6 of the rolling shutter gate in dependence on the scanning angle α in accordance with the function

$$r = \frac{b}{sin α} ,$$

whereas a set of characteristic curves having the functions

$$r = \frac{h}{cos α}$$

applies to the distance measurement detector beam impacting on the leading or lower gate edge 9, with h being a time-dependent quantity.

Without entering into a more detailed mathematical representation which may readily be reproduced by a person having skill in the art, it can at any rate be noted by referring to FIG. 3 that under the condition of a very high angular velocity of the distance measurement detector beam relative to the gate lowering velocity, one may roughly assume a constant height h of the leading or lower gate edge 9 during the time period during which the distance detector beam impacts on precisely this lower gate edge 9 while not yet impacting on the lateral boundary 6 of the gate aperture 4, as is represented by the characteristic curves of

$$r = \frac{h}{cos α}$$

drawn as solid lines in FIG. 3 and designated by 21 in FIG. 3.

As soon, however, as it is not possible any more to disregard the lowering velocity of the rolling shutter gate 1 in comparison with the scanning velocity, or the angular velocity of the distance detector beam, then the characteristic curves

$$r = \frac{h}{cos α}$$

undergo a downward shift during each scanning cycle in accordance with the broken lines 22 drawn in FIG. 3.

Under consideration of all relevant pairs of values, the respective position of the gate closure edge results in respective constant values for the gate position h′, namely,

h′=r₁ cos α₁=r₂ cos α₂= . . . =rₙ cos αₙ.

When the distance scanning detector 12 inputs distance measurement values to the monitoring control means, which distance measurement values are then compared to distance limit values stocked in storage means in accordance with the reflections carried out in the foregoing with regard to FIG. 2 and FIG. 3, it may thus be seen that a regular gate closing process will be recognized and a deactivation of the drive mechanism will not be triggered by an alarm signal from the monitoring control means if the distance measurement values are equal to the distance limit values within predetermined tolerance limits.

On the other hand, whenever a somewhat unexpected lower distance measurement value is signalled by the distance scanning detector 12 at a particular angular position of the distance measurement detector beam, this indicates an impact of the distance measurement detector beam on an obstacle 8 having intruded into the gate aperture 4 during the closing movement of the gate. This conclusion is valid both for the scan phase during which the distance measurement detector beam impacts on the leading or lower gate edge 9 and for that part of a scanning cycle during which the distance measurement detector beam impacts on the lateral boundary 6 of the gate aperture 4.

In the presently specified system it is thus possible, with the aid of a single distance measurement means disposed in a corner of a rectangular gate aperture and detecting a 90-degree scan area within the gate closure plane, to monitor the entire gate closure plane without having to set up a light grid consisting of a multiplicity of photoelectric barriers across this gate closure plane.

If the drive mechanism 7 for the gate 1 is configured such that a constant closing velocity of the leading gate edge 9 can be assumed, then consecutive automatic switching of the stocked distance limit values from characteristic curve 21 to characteristic curve 21, or from characteristic curve 22 to characteristic curve 23 (the latter for the case of comparatively slow scanning by the distance scanning detector 12), may be provided in the monitoring control means.

In accordance with an advantageous development of the presently specified system it is, however, also possible to perform a respective velocity measurement with regard to the closing velocity of the leading or lower gate edge 9 with the aid of the distance measurement detector beam and the distance scanning detector 12 in so combination with the monitoring control means itself, in which case consecutive measurement values for the scanning angle α=0 (namely, r=h) of consecutive scanning cycles are evaluated; cf. the practical example according to FIGS. 1 and 2. At high operating speeds of the electronic circuitry employed in the monitoring control means, the purpose of a velocity measurement may also be achieved by evaluating distance measurement values occurring during one and the same scanning cycle for the scanning angle α=0 and for a scanning angle somewhat different from 0.

Independently of an accurate mathematical determination of the respective distance limit values to be stocked in storage means, these may also be obtained by performing initialization runs of the gate 1 in closing movement, during which initialization runs the distance measurement values determined at a respective angular scanning velocity are gathered and stored in the storage means, with these storage means then being addressed, during operation, in dependence on the respective gate position measured by the distance scanning detector, and in a given case also in dependence on the determined gate velocity, in order to retrieve the distance limit values for the comparison with the respective distance measurement values.

FIG. 4 shows an embodiment to which a wave profile or serrated profile, shown under 24 in FIG. 4, has been fastened in order to improve the reflective comportment of the leading or lower gate edge 9 with regard to the distance detector beam, particularly in operation phases in which the leading gate edge 9 is situated close to the closure position.

FIGS. 5 to 8 illustrate gates or doors or closure members to which the presently specified system may be applied. In FIGS. 5 to 8, components corresponding to those of FIGS. 1 to 4 are designated by same reference numerals.

In the embodiment of FIG. 5, the scanning mechanism, i.e., for example, a rotary mirror of the distance scanning detector 12, is arranged—similarly to the case of the embodiment of FIG. 1—in a lower corner of the gate aperture 4 and located in proximity of a post 25 limiting the gate aperture and opposite a slotted post 26 across the gate aperture 4, with the posts 25 and 26 thus supporting a cross member 27 provided with a rolling guide means, on which a gate leaf or door leaf 28 is suspended so as to be displaceable by means of a drive mechanism 7—which is only indicated schematically in FIG. 5—in order to expose or close the gate aperture 4. The direction of rotation of the rotary mirror is selected, for instance, to be counter-clockwise relative to the position shown in FIG. 5, such that the distance detector beam initially impacts on the lower leading edge of the gate leaf 28 and in the process—in accordance with the preceding discussion—either performs a velocity measurement of the closing movement of the gate leaf 28 from scanning cycle to scanning cycle, or performs this velocity measurement by comparison of distance measurement values juxtaposed in a small pan control range within one and the same scanning cycle, to independently thereof perform the evaluation of the distance limit value characteristic curves discussed in connection with FIG. 3. After a certain duration of scanning the distance detector beam, the latter then impacts on the boundary constituted by the cross member 27, so that the distance measurement values obey the distance measurement limit values corresponding to characteristic curve 20 of FIG. 3.

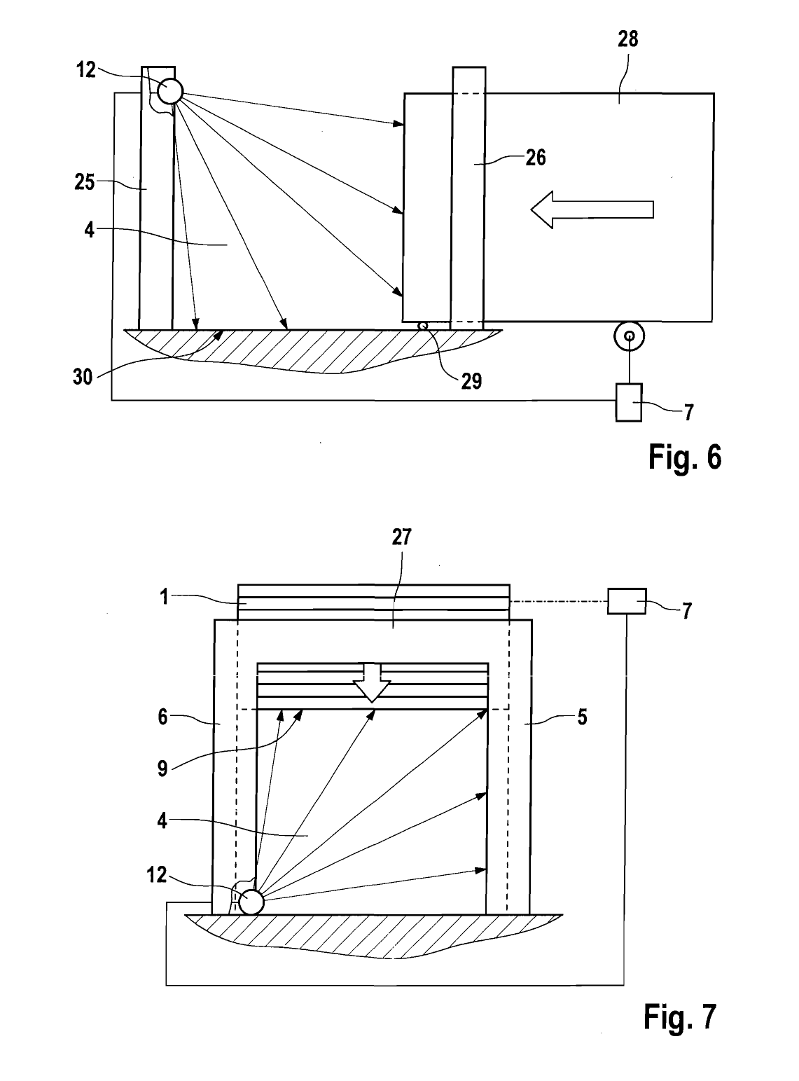

If, in accordance with FIG. 6, the presently specified system is applied to a horizontally displaceable gate leaf 28 which is not suspended at an upper cross member but is, for instance, supported on rollers against a planar support as indicated schematically in FIG. 6 under 29 and 30, then the scanning mechanism, e.g. the rotary mirror of the distance scanning detector 12, must be disposed at the upper end of the post 25, in which case the distance measurement detector beam initially impacts horizontally on the upper corner at the leading edge of the door leaf 28, to then impact—in accordance with the reflections made by referring to FIG. 3 with regard to the set of characteristic curves 21 and 22 of distance limit values—on the leading edge, while the distance measurement detector beam moves downward along the gate edge in a clockwise rotation, to then finally impact on the planar support or the ground 30 of the horizontally displaceable door leaf 28, and then arrives downwards at a vertical position in accordance with the reflections according to FIG. 3 of the characteristic curve 20.

The embodiment of FIG. 7 is not fundamentally different from the system illustrated in FIG. 1. It is evident from the representation of FIG. 7 that a rotary mirror or some other deflection means of the distance scanning detector 12 may, as a matter of course, also be disposed in the respective other, lower corner of the rectangular gate aperture 4 to be covered by the segmented gate 1, such that in contrast with FIG. 1, FIG. 7 shows a view, for instance, from the respective other side of the plane of the door leaf; this may be seen from the designation of the guide members 5 and 6 in FIG. 7 in difference from the designation of the guide members 5 and 6 in FIG. 1. In addition, the embodiment of FIG. 7 differs from the one of FIG. 1 in the fact that the guide members 5 and 6 in the embodiment according to FIG. 7 are connected by a slotted cross member 27, through the slot aperture of which the gate leaf is lowered into the closure position or raised into the opened position by the drive mechanism 7.

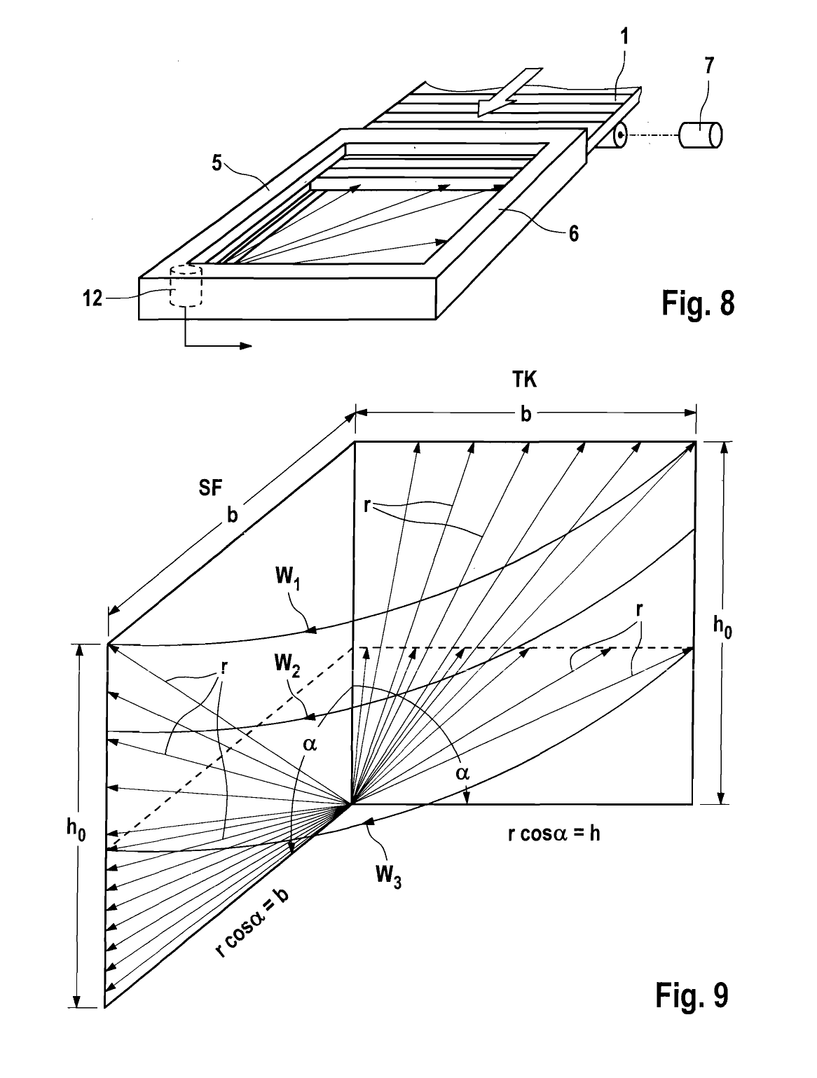

It should be noted, however, that the position of the plane of the rectangular gate aperture adapted to be closed by the presently specified system is not restricted to a vertical plane, as is illustrated in FIG. 8. This plane may equally assume a certain angle with the vertical line or be oriented horizontally, as is illustrated in FIG. 8. For example in the cases of a displaceable construction site cover, swimming pool covers, loading hatch covers of cargo ships, etc. it may be of interest to close such openings while avoiding a collision of the leading gate edge with an obstructing object by corresponding monitoring.

Instead of accurate geometrical considerations for the purpose of determining the stocked distance limit values to be compared to the distance measurement values actually determined based on the distance measurement detector beam, it may be expedient in all of the embodiments described in the foregoing to guide the distance measurement detector beam through repeated scanning cycles along a leading gate edge and along a lateral boundary of the gate guide means, and in the process to gather respective distance measurement values which are then stored into a storage as distance measurement limit values at a certain tolerance. During scanning of the leading gate edge and based on appropriate addressing, this storage will then furnish—depending on a possibly predetermined, constant gate closure velocity, or depending on a gate closure velocity determined from scanning cycle to scanning cycle, or depending on a gate velocity determined temporarily at the beginning of a scanning cycle—precisely those limit values of the length of the distance measurement scanning beam which indicate an obstructing object if they are not attained, and bring about a deactivation or/and a reversal of the motor drive of the gate leaf or gate. During a scan of the distance measurement detector beam along the lateral straight guidance of the gate, the stocked limit values remain unchanged over the one portion of the characteristic curve 20 of FIG. 3 that remains between the point of coincidence of the current characteristic curve 21 or 22 of FIG. 3 with the single characteristic curve 20 up to a length of the distance measurement scanning beam r which is equal to the width b of the gate aperture.

FIG. 9 finally shows a three-dimensionally conceived diagram which facilitates the reflections with regard to the limit values having to be stocked for the distance scanning detector 12. Namely, these do not necessarily have to be limit value characteristic curves as represented, for instance, in FIG. 3 and discussed in the foregoing.

As the scanning velocity or angular velocity of the distance scanning detector 12 may be extraordinarily high, such that the closing gate may be considered to be stationary during one scanning pass of the distance scanning detector 12, and thus the leading gate edge may be considered to be assuming a certain elevational position h, h₁, h₂, etc. during one pass, it is quite possible to already perform the trigonometric processing of the determined quantities r in the distance scanning detector 12 and then compare them to constant limit values.

FIG. 9 shows a diagram plane TK corresponding to the plane of the gate edge being lowered, wherein the width of the gate aperture is designated by b.

While the detector beam scans the lower gate edge being situated at a particular height, the constant value h will always result by multiplication of the value for r as determined by the distance scanning detector and the instantaneous scanning angle upon counter-clockwise scanning by multiplication of r cos α.

When the scanning beam then impacts on the corner between the leading gate edge and the boundary of the gate aperture opposite the distance scanning detector, the diagram plane valid for the ensuing calculation of limit value is the diagram plane SF which is drawn in FIG. 9 at an angle of 90 deg. relative to the plane TK, and which represents circumstances at the time of impact of the detector beam on the lateral guide member of the gate plane.

Here it is true for the detector beam, the length of which is multiplied with the scanning angle cos α, that the result will always be the quantity b, which applies from impact of the detector beam on the corner between the leading gate edge and the lateral gate aperture boundary to when the detector beam is oriented in a horizontal direction.

Thus, whenever the detector beam impacts on the corner between leading gate edge and lateral boundary of the gate aperture, it is necessary to change over the view from diagram plane TK to diagram plane SF, as is indicated by arcuate arrows W₁, W₂ and W₃ in FIG. 9 for respective diminishing heights h of the leading gate edge above ground.

By means of corresponding multiplication rules in the distance scanning detector in dependence on the respective instantaneous height of the leading gate edge it is achieved that the limit value to be stocked and to which an evaluation result of the distance measurement is compared, is a constant.

Lastly it should be noted that the presently specified teaching may also be employed by embodiments where two gate leaves approach each other symmetrically, such that the distance scanning apparatus is located in proximity of the meeting point of the two gate leaves and then executes a scanning range of the scanning beam across 180° in a correspondingly modified embodiment. Such developed embodiments are considered to be encompassed by the annexed claims.

1. A method for controlling a gate (1) which is adapted to be displaced by means of a motorized drive mechanism (7) on at least one straight guide means (5, 6) across a rectangular gate aperture (4) from an opened position into a closure position, in such a way that during the movement of the gate into the closure position an intrusion by an obstructing object (8) into the respective remaining gate aperture is detected as a result of a detector beam interruption and brings about a deactivation or/and reversal of the motorized drive mechanism (7), characterized in that, in proximity of a corner of the rectangle of the gate aperture which is, in the closure position, situated in the vicinity of the leading gate edge (9) with regard to the closing movement, a distance measurement detector beam is scanned across an angular range of preferably 90 deg. in the plane of gate movement by means of a distance measurement scanning detector (12), with distance measurement values of said distance measurement detector detected during this scanning movement or distance reference values trigonometrically converted to the gate dimensions being compared to respective distance measurement limit values stored in storage means and corresponding to the impact of the distance measurement detector beam on the leading gate edge (9) and on a boundary of the rectangular gate aperture (4) parallel to the moving direction of the gate or compared to such distance measurement limit reference values trigonometrically converted to the gate dimension, and that upon occurrence of distance measurement values that are smaller in comparison with these, an alarm signal triggering a deactivation or/and reversal is generated.

2. The method according to claim 1, characterized in that the distance measurement limit values which are stocked for distance measurement values gathered upon impact on the leading gate edge (9) are subjected to a modulation that is dependent on the gate movement velocity.

3. The method according to claim 2, characterized in that the evaluation of the distance measurement limit values stocked for the distance measurement values with regard to the leading gate edge (9) is also performed, in dependence on the gate movement velocity, during a single scanning movement of the distance measurement detector beam across the scanning range of preferably 90 deg.

4. The method according to any one of claims 1 to 3, characterized in that the distance measurement limit values are gathered with the aid of initialization runs of the gate (1) in closing movements and stocked in a storage adapted to be addressed in dependence on the gate velocity.

5. The method according to any one of claims 2 to 4, characterized in that for the modulation of the distance measurement limit values a velocity measurement by the distance measurement detector beam in accordance with its impact on the leading gate edge (9) itself is performed either for small scanning ranges of the distance measurement detector beam within a same scan interval or, on the other hand, from scan interval to scan interval.

6. A device for implementing the method according to any one of claims 1 to 5, characterized in that in a corner of the rectangular gate aperture (4) which, in the gate closure position, is situated close to the leading gate edge with regard to the gate closing movement, the distance measurement scanning detector (12) comprises a rotary mirror (15) which interacts with a laser-radar detector.

7. The device according to claim 6, characterized in that a reflective strip (24) provided with a wave profile or serrated profile is fastened to the leading gate edge, which ensures a sufficient reflection of the leading gate edge even at large angles of the distance measurement detector beam relative to the plumb line of the leading gate edge (FIG. 4).
